(19) United States
(12) Patent Application Publication
(10) Pub. No.: US 2013/0094982 A1
(43) Pub. Date: Apr. 18, 2013

(54) BRUSHLESS MOTOR AND ELECTRIC PUMP

(71) Applicant: AISAN KOGYO KABUSHIKI KAISHA, Aichi-ken (JP)

(72) Inventor: Atsushi Sugimoto, Obu-shi (JP)

(73) Assignee: AISAN KOGYO KABUSHIKI KAISHA, Aichi-ken (JP)

(21) Appl. No.: 13/647,550

(22) Filed: Oct. 9, 2012

(30) Foreign Application Priority Data
Oct. 14, 2011 (JP) 2011-226582

(51) Int. Cl. H02K 1/06; F04D 13/06

(52) U.S. Cl. 417/423.7; 310/216.004

(57) ABSTRACT

A brushless motor comprises a rotor and a stator comprising a plurality of core plates laminated on one another. The core plates include a plurality of teeth portions. The plurality of core plates includes a first core plate and a second core plate, a combination of magnetic resistances of the teeth portions of the first core plate being adjusted at a first condition, and a combination of magnetic resistances of the teeth portions of the second core plate being adjusted at a second condition. Magnetic resistances of magnetic paths formed by the plurality of laminated teeth portions are adjusted to be same by adjusting a ratio of a number of the first core plates to a number of the second core plates.

### CROSS-REFERENCE TO RELATED APPLICATION

This application claims priority to Japanese Patent Application No. 2011-226582 filed on Oct. 14, 2011, the contents of which are hereby incorporated by reference into the present application.

### TECHNICAL FIELD

The present teachings relate to a brushless motor and an electric pump.

### DESCRIPTION OF RELATED ART

In a brushless motor, a plurality of teeth is provided on a stator disposed outside of a rotor, and a coil is wound around the plurality of teeth. When rotating the rotor, on-off of a current that flows through the coil of each tooth is controlled in order to induce a magnetic flux among the teeth and generate a driving force for rotating the rotor. The driving force that rotates the rotor varies depending on magnetic resistance of a magnetic path along which the magnetic flux flows (i.e., a space between teeth through which the magnetic flux flows). Therefore, if the magnetic resistance varies for each magnetic path, the driving force that rotates the rotor varies periodically and a rotational vibration is generated on the rotor. Japanese Patent Application Publication No. H9-261902 proposes a technique for solving this problem. The technique described in Japanese Patent Application Publication No. 119-261902 involves designing a number of turns of a coil wound around each tooth or designing a width, a thickness, and the like of each tooth so that the magnetic resistance of each magnetic path is the same. Accordingly, a fluctuation in the driving force that rotates the rotor is suppressed.

### BRIEF SUMMARY OF INVENTION

With the technique described in Japanese Patent Application Publication No. H-19-261902, a design which equalizes magnetic resistances of magnetic paths is adopted and a stator is manufactured based on the design. Therefore, with this technique, the stator must be manufactured with high accuracy in order to equalize the magnetic resistances of the magnetic paths. In particular, when there is only a slight difference in magnetic resistances, the accuracy required for the stator is extremely high.

The present teachings provide a technique capable of equalizing magnetic resistances of magnetic paths even if a stator is not manufactured with high accuracy.

A brushless motor disclosed in the present specification comprises: a rotor; and a stator disposed outside of the rotor, the stator comprising a plurality of core plates laminated on one another. Each of the plurality of core plates includes a plurality of teeth portions arranged at an interval in a circumferential direction of the rotor and, when the plurality of core plates is laminated on one another, the teeth portions of the core plates are respectively laminated on one another. The plurality of core plates includes a first core plate and a second core plate, a combination of magnetic resistances of the teeth portions of the first core plate being adjusted at a first condition, and a combination of magnetic resistances of the teeth portions of the second core plate being adjusted at a second condition. Magnetic resistances of magnetic paths formed by the laminated teeth portions are adjusted to be same by adjusting a ratio of a number of the first core plates to a number of the second core plates.

With this brushless motor, the plurality of core plates includes the first core plate and the second core plate which respectively have different combinations of magnetic resistances of the teeth portions. In addition, by adjusting the ratio of the number of the first core plates to the number of the second core plates, the magnetic resistances of the magnetic paths can be changed. Therefore, in this brushless motor, the ratio of the number of the first core plates to the number of the second core plates can be adjusted when the plurality of core plates is laminated on one another so that the magnetic resistances of the magnetic paths become the same. Consequently, even if the first core plates and the second core plates are not highly accurate, the magnetic resistances of the magnetic paths can be adjusted to be the same.

The phrase “the magnetic resistances are adjusted to be the same” as used herein does not necessarily mean that the magnetic resistances of the magnetic paths are adjusted to be completely the same but means that magnetic resistances of the magnetic paths are adjusted so that differences between the magnetic resistances are reduced. Accordingly, even a case where there is a minute difference among the magnetic resistances of the magnetic paths which cannot be adjusted by adjusting the ratio of the number of the first core plates to the number of the second core plates falls under the phrase “magnetic resistances are adjusted to be same” described above.

Furthermore, the present specification discloses a novel electric pump which uses the brushless motor described above. In other words, the electric pump disclosed in the present specification comprises: the brushless motor described above; an impeller driven by the brushless motor; and a pump chamber accommodating the impeller, the impeller being capable of rotating in the pump chamber. Since the electric pump uses the brushless motor described above, a rotational vibration of the impeller can be suppressed and pump efficiency can be increased.

### BRIEF DESCRIPTION OF DRAWINGS

FIG. 1 is a schematic longitudinal sectional view of an electric pump according to a first embodiment;

FIG. 2 is a plan view of a stator;

FIG. 3 is a sectional view taken along line III-III in FIG. 2;

FIG. 4 is a diagram showing a stator according to a first modification;

FIG. 5 is a sectional view taken along line V-V in FIG. 4;

FIG. 6 is a diagram showing a stator according to a second modification; and

FIG. 7 is a diagram showing a stator according to a third modification.

### DETAILED DESCRIPTION OF INVENTION

In one aspect of the present teachings, at least one teeth portion of the first core plate may include a first portion having a first cross section area, and the second core plate may include a second portion corresponding to the first portion, the second portion having a second cross section area which is different from the first cross section area. According to such a configuration, the magnetic resistance of a teeth portion can be readily varied by varying the cross section area of the teeth portion.

Moreover, when varying the cross section area of the first portion of the teeth portion, each of the teeth portions comprises a tip end portion opposing an outside surface of the rotor with an interval in between, a base end portion connected to a yoke, and a middle portion disposed between the tip end portion and the base end portion. A coil is wound around the middle portion, and the first portion is located at the tip end portion or the middle portion.

In addition, the first portion of the first core plate may not have a through hole, and the second portion of the second core plate may have a through hole. Even with such a configuration, the magnetic resistance of the teeth portion can be readily varied depending on whether or not the through hole is provided.

Representative, non-limiting examples of the present teachings will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved brushless motor and electric pump, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

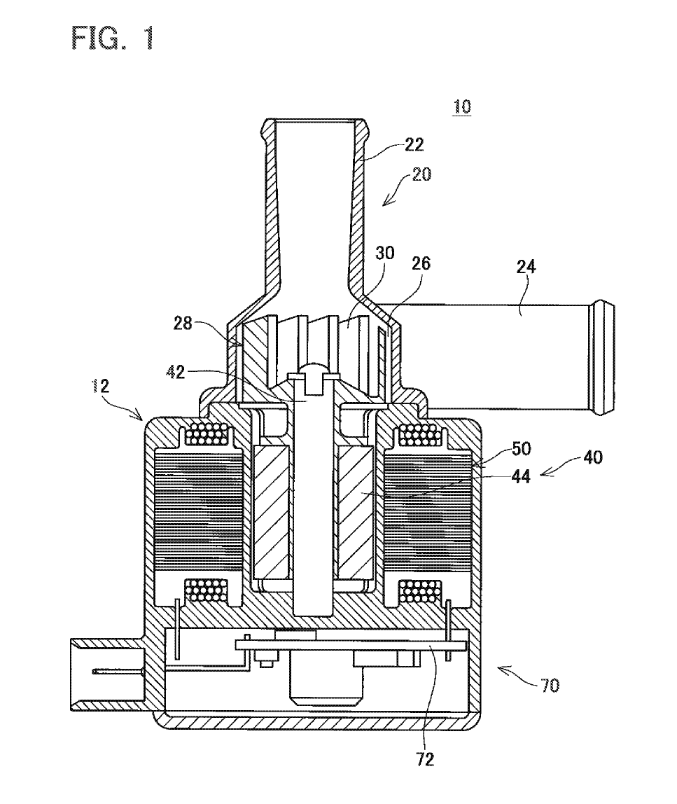

An electric pump 10 according to a first embodiment may be installed in an engine room of an automobile and be used to circulate cooling water for cooling an engine, an inverter, and the like. As shown in FIG. 1, the electric pump 10 comprises a pump portion 20, a motor portion 40, and a circuit portion 70.

The pump portion 20 is formed above a casing 12. The pump portion 20 comprises a pump chamber 26. An inlet 22 and an outlet 24 formed in the casing 12 are connected to the pump chamber 26. The inlet 22 is connected to an upper end of the pump chamber 26. The inlet 22 extends in a direction in which an axis of rotation of a rotating body 28 extends. The outlet 24 is connected to an outside surface of the pump chamber 26. The outlet 24 extends in a tangential direction of the outside surface of the pump chamber 26. An impeller 30 of the rotating body 28 is disposed in the pump chamber 26.

The motor portion 40 is disposed below the pump portion 20. The motor portion 40 comprises a rigid shaft 42, the rotating body 28, and a stator 50. A lower end of the rigid shaft 42 is fixed to the casing 12. The rigid shaft 42 extends vertically in the casing 12 and a tip end of the rigid shaft 42 reaches inside the pump chamber 26. The rotating body 28 is attached to the rigid shaft 42 so as to be capable of rotating. The rotating body 28 comprises the impeller 30 and a rotor portion 44. A plurality of blades is formed at regular intervals on an upper surface of the impeller 30. The rotor portion 44 having a tubular shape is provided below the impeller 30. The rotor portion 44 is formed of a magnetic material and is magnetized so as to have a plurality of magnetic poles in a circumferential direction. The impeller 30 and the rotor portion 44 are integrally connected. Therefore, when the rotor portion 44 rotates, the impeller 30 rotates as well. The stator 50 is disposed outside the rotor portion 44 and opposes the rotor portion 44. A detailed configuration of the stator 50 will be described later.

The circuit portion 70 is disposed below the motor portion 40. The circuit portion 70 comprises a motor drive circuit 72 which controls feeding of power to the stator 50. The motor drive circuit 72 is connected to an external power supply (not shown; for example, a vehicle-mounted battery) by a wiring (not shown). The motor drive circuit 72 supplies power supplied from the external power supply to the motor portion 40.

Next, the stator 50 will be described in greater detail. As shown in FIG. 1, the stator 50 is embedded in the casing 12 and is surrounded by a resin material (in other words, a material of the casing 12). As shown in FIGS. 1 to 3, the stator 50 is formed by laminating a plurality of types of core plates 51a and 51b (61a and 61b) on one another. Specifically, the stator 50 is formed by a plurality of first core plates 51a (61a) that is centrally laminated and a plurality of second core plates 51b (61b) that is laminated on surfaces both above and below the laminated first core plates 51a (61a). The first core plates 51a (61a) and the second core plates 51b (61b) are formed of magnetic steel sheets.

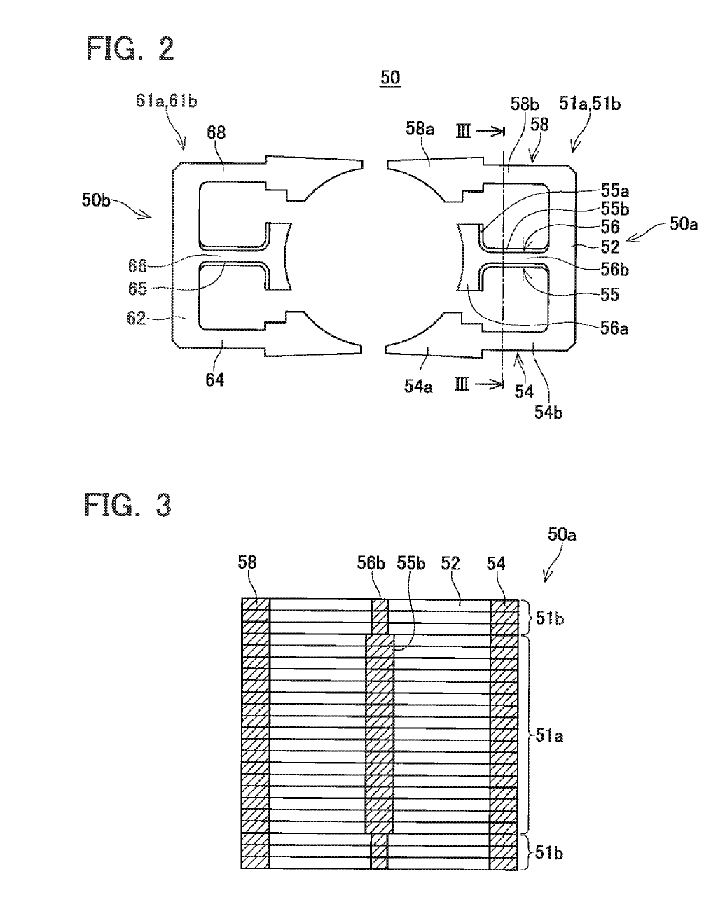

As shown in FIG. 2, the stator 50 comprises a pair of stator blocks 50a and 50b. The pair of stator blocks 50a and 50b is disposed at an interval (specifically, an interval of 180 degrees) in a circumferential direction of the rotor portion 44. As a result, the pair of stator blocks 50a and 50b is symmetrically disposed with the rotor portion 44 in between, and the rotor portion 44 is disposed between the pair of stator blocks 50a and 50b. Moreover, as is apparent from FIG. 2, the groups of teeth of the stator blocks 50a and 50b extend parallel to each other. Therefore, in a plan view of the stator 50, the stator 50 is shaped like a rectangle having long sides and short sides. In other words, the stator 50 is a flat stator.

The stator block 50a is constituted by the first core plate 51a and the second core plate 51b. The stator block 50b is constituted by the first core plate 61a and the second core plate 61b. Moreover, the stator block 50b has a same configuration as the stator block 50a with the exception of being symmetrically disposed with respect to the rotor portion 44. In other words, the first core plate 51a and the first core plate 61a, and the second core plate 51b and the second core plate 61b, share the same configurations. Therefore, the first core plate 51a and the second core plate 51b constituting the stator block 50a will be mainly described below.

As shown in FIG. 2, the first core plate 51a comprises a yoke 52, and three teeth 54, 55, and 58 fixed to the yoke 52. The three teeth 54, 55, and 58 extend parallel to each other. Widened portions 54a, 55a, and 58a are respectively formed on tip ends of the three teeth 54, 55, and 58. The widened portions 54a, 55a, and 58a oppose the rotor portion 44 with an interval in between. Base ends of the three teeth 54, 55, and 58 are fixed to the yoke 52. A coil (not shown) is wound around middle portions 54b, 55b, and 58b of the three teeth 54, 55, and 58 Among the three teeth 54, 55, and 58, a cross section area of the middle portion 55b of the central tooth 55 is set to a first cross section area A1 and a magnetic resistance of the central tooth 55 is adjusted to R1. In addition, the teeth 54 and 58 at both ends have a same shape and magnetic resistances of the teeth 54 and 58 are adjusted to R2. Therefore, in the first core plate 51a, magnetic resistances of the teeth 54, 55, and 58 are adjusted to a combination (R2, R1, and R2).

In a similar manner to the first core plate 51a, the second core plate 51b comprises the yoke 52, and three teeth 54, 56, and 58 fixed to the yoke 52. With the second core plate 51b, only a configuration of the central tooth 56 among the three teeth differs from a configuration of the first core plate 51a. In other words, a cross section area A2 of a middle portion 56b of the tooth 56 is set smaller than the cross section area A1 of the middle portion 55b of the tooth 55 of the first core plate 51a (refer to FIG. 3). Therefore, magnetic resistance of the tooth 56 is set to a value R1′ that is greater than the magnetic resistance R1 of the tooth 55. Moreover, since the teeth 54 and 58 on both ends of the second core plate 51b are the same as those of the first core plate 51a, magnetic resistance thereof is adjusted to R2. Therefore, in the second core plate 51b, magnetic resistances of the teeth 54, 56, and 58 are adjusted to a combination (R2, R1′, and R2).

In the stator block 50a described above, magnetic resistances of magnetic paths through which a magnetic flux flows when driving the rotor portion 44 are adjusted to be same by adjusting a ratio of a number of the first core plates 51a to a number of the second core plates 51b. In other words, in the stator block 50a, a magnetic path (hereinafter referred to as a magnetic path 1) through a teeth group 58, a yoke group 52, and teeth groups (55 and 56), a magnetic path (hereinafter referred to as a magnetic path 2) through a teeth group 54, the yoke group 52, and the teeth groups (55 and 56), and a magnetic path (hereinafter referred to as a magnetic path 3) through the teeth group 58, the yoke group 52, and the teeth group 54 are formed. In the magnetic path 1 and the magnetic path 3, a magnetic flux flows through a part of the yoke 52 between one end to a center thereof, and in the magnetic path 3, a magnetic flux flows from one end to another cad of the yoke 52. Therefore, the magnetic path 1 and the magnetic path 2 have a same magnetic path length and also same magnetic resistance. Meanwhile, the magnetic path 3 has a longer magnetic path length than the magnetic paths 1 and 2, which gives the magnetic path 3 magnetic resistance that differs from the magnetic paths 1 and 2 on its own. Therefore, in the present embodiment, based on the magnetic resistance of the magnetic path 3, magnetic resistances of central teeth groups (55 and 56) of the stator block 50a are adjusted so that the magnetic resistances of the magnetic paths 1 and 2 become the same as the magnetic resistance of the magnetic path 3.

Specifically, first, a predetermined number (a design value) of the first core plate 51a is laminated on one another, and a predetermined number (a design value) of the second core plate 51b is laminated on one another on surfaces above and below the laminated first core plates 51a. The magnetic resistance of the magnetic path 3 is measured. Next, the magnetic resistance of the magnetic path 1 or the magnetic path 2 is measured. When the measured magnetic resistance of the magnetic path 3 differs from the measured magnetic resistance of the magnetic path 1 or the magnetic path 2, the number of laminated first core plates 51a and the number of laminated second core plates 51b are varied (in other words, a ratio of the numbers of core plates is adjusted). For example, when the magnetic resistance of the magnetic path 3 is greater than the magnetic resistance of the magnetic path 1 or the magnetic path 2, the magnetic resistance of the magnetic path 1 or the magnetic path 2 must be increased. To this end, the number of laminated first core plates 51a is reduced while the number of laminated second core plates 51b is increased by a same amount as the reduction. Conversely, when the magnetic resistance of the magnetic path 3 is lower than the magnetic resistance of the magnetic path 1 or the magnetic path 2, the magnetic resistance of the magnetic path 1 or the magnetic path 2 must be reduced. To this end, the number of laminated second core plates 51b is reduced while the number of laminated first core plates 51a is increased by a same amount as the reduction. After the ratio of the number of the first core plates 51a to the number of the second core plates 51b is adjusted in this manner, the magnetic resistance of the magnetic path 3 and the magnetic resistance of the magnetic path 1 or the magnetic path 2 are measured once again. The measurement of magnetic resistances and the adjustment of the ratio of numbers of the core plates are performed until the magnetic resistance of the magnetic path 3 and the magnetic resistance of the magnetic path 1 or the magnetic path 2 become the same. Accordingly, the magnetic resistances of the magnetic paths of the stator block 50a are adjusted to be the same.

Moreover, as described earlier, the stator block 50b has the same configuration as the stator block 50a with the exception of being symmetrically disposed with respect to the rotor portion 44. In addition, the first core plate 61a and the second core plate 61b have the same configurations as the first core plate 51a and the second core plate 51b described above. In other words, a cross section area A1 of a middle portion of a central tooth 65 of the first core plate 61a is set larger than a cross section area A2 of a middle portion of a central tooth 66 of the second core plate 61b. Therefore, in the stator block 50b, magnetic resistances of magnetic paths through which a magnetic flux flows when driving the rotor portion 44 are similarly adjusted to be same by adjusting a ratio of a number of the first core plates 61a to a number of the second core plates 61b. Moreover, since the stator block 50a and the stator block 50b have the same configuration, the magnetic resistances of the magnetic paths of the stator block 50a and the magnetic resistances of the magnetic paths of the stator block 50b are also the same.

Next, operations of the electric pump 10 will be described. When power is supplied to each coil of the stator 50 from the motor drive circuit 72, the rotor portion 44 rotates around the rigid shall 42. As a result, the impeller 30 rotates and cooling water is suctioned into the pump chamber 26 via the inlet 22. Pressure of the cooling water suctioned into the pump chamber 26 is increased by the rotation of the impeller 30 and the cooling water is discharged to outside of the casing 12 from the outlet 24. As described above, since the magnetic resistances of the magnetic paths of the stator 50 are adjusted to be same, a fluctuation in a driving force that drives the rotor portion 44 is suppressed. As a result, rotational vibrations of the rotor portion 44 and the impeller 30 are suppressed and the cooling water can be discharged in a stable manner.

As described earlier, with the electric pump 10 according to the present embodiment, magnetic resistances of the magnetic paths formed in the stator 50 are adjusted by adjusting a ratio of numbers of the first core plates 51a and 61a to numbers of the second core plates 51b and 61b. Therefore, the magnetic resistances of the magnetic paths can be adjusted by measuring the magnetic resistances and adjusting the ratio of numbers of the core plates in a state where the plurality of core plates 51a, 51b, 61a, and 61b are laminated on one another. Consequently, the magnetic resistances of the magnetic paths of the stator 50 can be adjusted without having to increase accuracy of the core plates 51a, 51b, 61a, and 61b.

The preferred embodiments of the present teachings have been described above, the explanation was given using, as an example, the present teachings is not limited to this type of configuration.

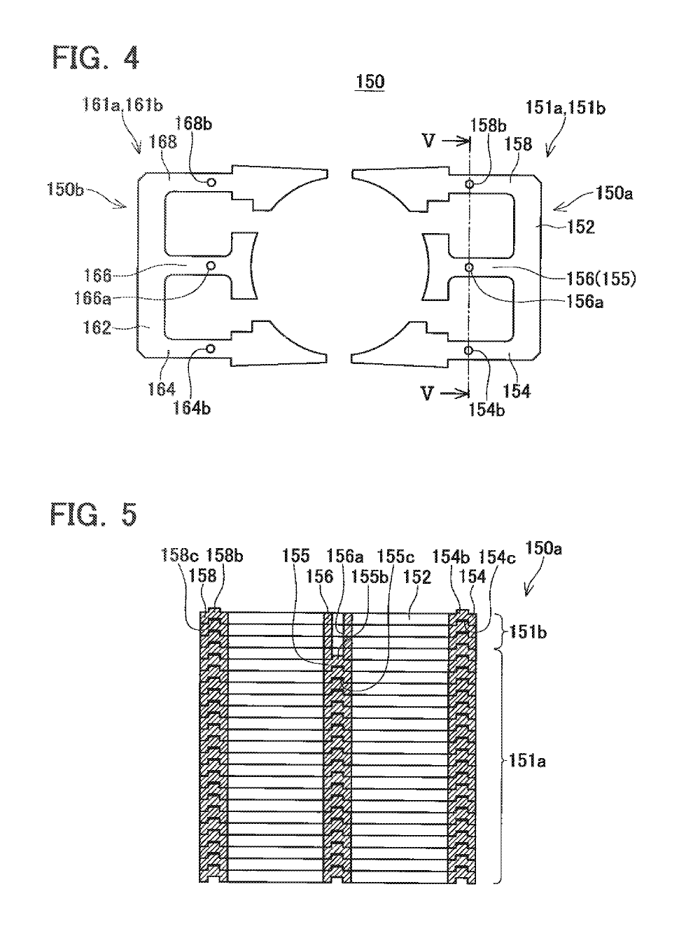

For example, a shape of the core plates constituting the stator is not limited to that according to the embodiment described above and the core plates may be shaped as shown in FIGS. 4 and 5. Hereinafter, a modification shown in FIGS. 4 and 5 will be described. As shown in FIG. 4, a stator 150 comprises a pair of stator blocks 150a and 150b. Since the stator block 150a and the stator block 150b have a same configuration, the stator block 150a will be described below.

As shown in FIGS. 4 and 5, the stator block 150a comprises a plurality of first core plates 151a and a plurality of second core plates 151b. The first core plates 151a are laminated on a lower end side of the stator block 150a. The second core plates 151b are laminated on an upper surface of the laminated first core plates 151a. Convex portions 154b, 155b, and 158b are respectively formed on upper surfaces of teeth 154, 155, and 158 of the first core plates 151a (refer to FIG. 5). In addition, concave portions 154c, 155c, and 158c are respectively formed on lower surfaces of the teeth 154, 155, and 158 of the first core plates 151a (refer to FIG. 5). As the convex portions 154b, 155b, and 158b of one first core plate 151a are fitted into the concave portions 154c, 155c, and 158c of another first core plate 151a laminated on an upper surface of the one first core plate 151a, the plurality of first core plates 151a is positioned with respect to, and laminated on, each other.

On the other hand, in the second core plates 151b, teeth 154 and 158 on both ends have a same configuration as in the first core plates 151a, with convex portions 154b and 158b formed on an upper surface thereof and concave portions 154c and 158c formed on a lower surface thereof. On the other hand, a through hole 156a is formed through central teeth 156 of the second core plates 151b. The convex portion 155b of an uppermost first core plate 151a fits into the through hole 156a of a lowermost second core plate 151b in FIG. 5. Accordingly, the first core plate 151a and the second core plate 151b are positioned. Moreover, since neither a convex portion nor a concave portion is formed on the central teeth 156 of the second core plates 151b, the central teeth 156 of adjacent second core plates 151b are not positioned with respect to each other. However, since convex portions 154b and 158b and concave portions 154c and 158c are formed on the teeth 154 and 158 on both ends of the second core plates 151b, positioning is achieved by the teeth 154 and 158 on both ends. Therefore, no problems arise even if the central teeth 156 are not positioned with respect to each other.

In the aforementioned stator 150 shown in FIGS. 4 and 5, the convex portion 155b and the concave portion 155c are formed on the central teeth 155 of the first core plates 151a while the through hole 156a is formed on the central teeth 156 of the second core plates 151b. Therefore, at portions where the convex portions and the concave portions (i.e., the through hole) are formed, a cross section area of the first core plates 151a exceeds a cross section area of the second core plates 151b. As a result, magnetic resistance of the central teeth 155 of the first core plates 151a is lower than magnetic resistance of the central teeth 156 of the second core plates 151b. Even in the modification shown in FIGS. 4 and 5, magnetic resistances of magnetic paths of the stator 150 can be adjusted by adjusting a ratio of a number of the first core plates 151a to a number of the second core plates 151b.

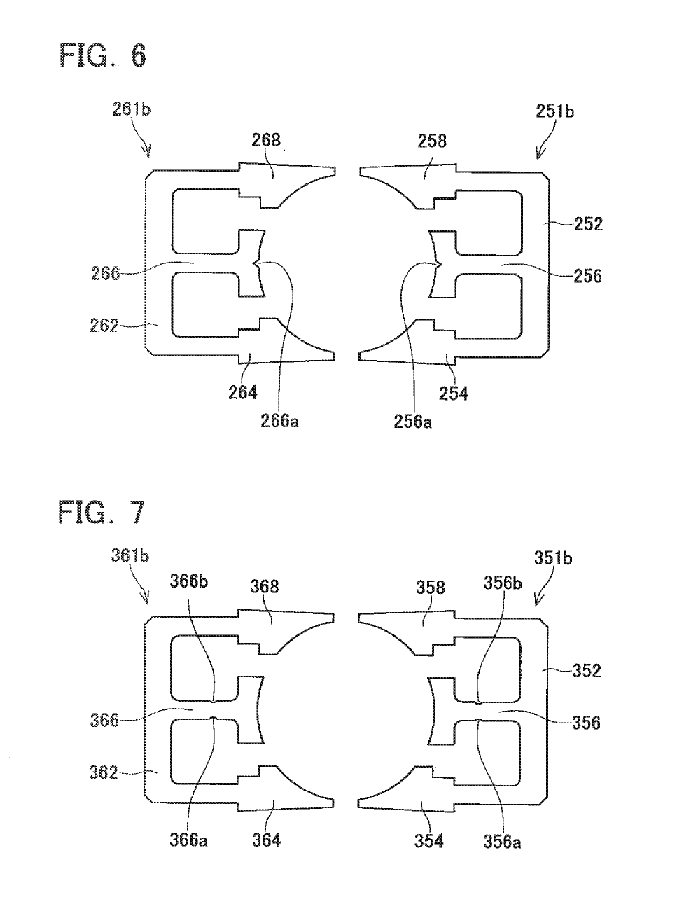

Alternatively, core plates 251b, 261b, 351 b, and 361b shown in FIGS. 6 and 7 can also be used to vary magnetic resistances of teeth. Specifically, in the core plates 251b and 261b shown in FIG. 6, grooves 256a and 266a are formed at tip ends of central teeth 256 and 266. Therefore, magnetic resistances of magnetic paths of a stator can be adjusted by adjusting a ratio of a number of core plates (not shown) in which grooves are not formed on central teeth to a number of the core plates 251b and 261b shown in FIG. 6.

In addition, in the core plates 351b and 361b shown in FIG. 7, grooves 356a, 356b, 366a, and 366b are formed on side surfaces of a middle portion (a portion wound with a coil) of central teeth 356 and 366. Therefore, magnetic resistances of magnetic paths of a stator can be adjusted by adjusting a ratio of a number of core plates (not shown) in which grooves are not formed on side surfaces of a middle portion of central teeth to a number of the core plates 351b and 361b shown in FIG. 7.

Moreover, while magnetic resistance of a central teeth group of a stator block is adjusted by adjusting a ratio of a number of first core plates having magnetic resistance of central teeth of the core plates adjusted to first magnetic resistance to a number of second core plates having magnetic resistance of central teeth of the core plates adjusted to second magnetic resistance in the respective embodiments described above, the present teachings are not limited to such examples. For example, magnetic resistance of a teeth group on one end of a stator block may be adjusted by adjusting a ratio of a number of third core plates having magnetic resistance of teeth on one end of the core plates adjusted to third magnetic resistance to a number of fourth core plates having magnetic resistance of teeth on one end of the core plates adjusted to fourth magnetic resistance. Furthermore, magnetic resistance of a teeth group on another end of a stator block may be adjusted by adjusting a ratio of a number of fifth core plates having magnetic resistance of teeth on another end of the core plates adjusted to fifth magnetic resistance to a number of sixth core plates having magnetic resistance of teeth on one end of the core plates adjusted to sixth magnetic resistance. As shown, magnetic resistances of teeth groups can be adjusted by adjusting a ratio of numbers of various types of core plates. Therefore, even when there is a significant variation in manufacturing errors of core plates and magnetic resistances of the magnetic path 1, the magnetic path 2, and the magnetic path 3 described above all differ from one another, the magnetic resistances of the magnetic paths 1, 2, and 3 can be adjusted to be the same.

What is claimed is:

1. A brushless motor comprising:
a rotor; and
a stator disposed outside of the rotor, the stator comprising a plurality of core plates laminated on one another; wherein
each of the plurality of core plates includes a plurality of teeth portions arranged at an interval in a circumferential direction of the rotor,
when the plurality of core plates is laminated on one another, the teeth portions of the core plates are respectively laminated on one another,
the plurality of core plates includes a first core plate and a second core plate, a combination of magnetic resistances of the teeth portions of the first core plate being adjusted at a first condition, and a combination of magnetic resistances of the teeth portions of the second core plate being adjusted at a second condition, and
magnetic resistances of magnetic paths formed by the laminated teeth portions are adjusted to be same by adjusting a ratio of a number of the first core plates to a number of the second core plates.

2. The brushless motor as in claim 1, wherein
at least one teeth portion of the first core plate includes a first portion having a first cross section area, and
the second core plate includes a second portion corresponding to the first portion, the second portion having a second cross section area which is different from the first cross section area.

3. The brushless motor as in claim 2, wherein
each of the teeth portions comprises a tip end portion opposing an outside surface of the rotor with an interval in between, a base end portion connected to a yoke, and a middle portion disposed between the tip end portion and the base end portion, and around which a coil is wound, and
the first portion is located at the tip end portion or the middle portion.

4. The brushless motor as in claim 2, wherein
the first portion of the first core plate has no through hole, and
the second portion of the second core plate has a through hole.

5. An electric pump comprising:
a brushless motor as in claim 1;
an impeller driven by the brushless motor; and
a pump chamber accommodating the impeller, the impeller being capable of rotating in the pump chamber.
